(19) United States
(12) Patent Application Publication
(10) Pub. No.: US 2005/0276895 A1
(43) Pub. Date: Dec. 15, 2005

(54) Apparatus and method for manufacturing molded processed food

(76) Inventors: Kohichiroh Fuchi, Hiroshima (JP); Toshihide Fujikawa, Hiroshima (JP); Katsutoshi Yamazaki, Hiroshima (JP)

Correspondence Address: LINIAK, BERENATO & WHITE, Suite 240, 6550 Rock Spring Drive, Bethesda, MD, 20817, US

(21) Appl. No.: 11/152,785

(22) Filed: Jun. 15, 2005

(30) Foreign Application Priority Data
Jun. 15, 2004 (JP) 2004-176632

(51) Int. Cl. A23G 1/00

(52) U.S. Cl. 426/512

(57) ABSTRACT

An apparatus and method for manufacturing molded processed food are provided which can manufacture planar molded processed food having both non-dense and dense states and heterogeneous eating texture. The apparatus comprises a mold mechanism 5 comprising an upper mold 3 and a lower mold 5, a rotation mechanism 4 for rotating at least one of the upper mold 3 and lower mold 5 around a rotation shaft 2 which is perpendicular to a mounting surface 11 of the lower mold 5, and a first moving mechanism 6 for moving the upper mold 3 in closer and separated directions to/from the lower mold 5.

### FIELD OF THE INVENTION

The present invention relates to an apparatus and method for manufacturing molded processed food used for breads, cooked rices, midday meal ingredients, and main materials for sushi or side dishes.

### DESCRIPTION OF THE RELATED ART

Conventionally, apparatuses for manufacturing molded processed food used in mold-processing planar (thin) food included such steps as filling a mixture of one or more food materials into a mold having predetermined geometries, heating and solidifying the mixture into a planar form, and then performing a punching out process to the mixture using a mold with predetermined geometries.

Methods for shaping gyoza (Chinese meat dumpling) wraps and doughs for wonton and snack include a stamping method that uses discs to thinly flat-rolls a dough. See Japanese Patent Application Laid-Open (Kokai) No. 1994-339334 (FIG. 1).

Methods for manufacturing cooked rices such as rice balls include one by rotating and flat-rolling a food material. See Japanese Patent Application Laid-Open (Kokai) No. 2003-259825.

Methods for shaping noodles include one by passing and flat-rolling a noodle band between rolls to shape noodles. See Japanese Patent Application Laid-Open (Kokai) No. 1996-308518 (FIG. 1) and No. 1994-269242 (FIGS. 1 and 8).

Other available methods include one by passing and flat-rolling cuttlefish legs between rolls (See Japanese Patent Application Laid-Open (Kokai) No. 1998-179094), and one by passing and flat-rolling seaweed sporophylls between rolls (See Japanese Patent Application Laid-Open (Kokai) No. 2001-231515 (FIGS. 1-3)).

However, conventional techniques for manufacturing planar molded processed food had demerits of an appearance of mixed patterns and color tone unique to mixedly formed food, and thick and rubber-like eating texture causing difficulty to produce heterogeneous eating texture with elasticity and softness.

Furthermore, application of those techniques as described in the above-cited patent documents could not produce such heterogeneous eating texture.

### SUMMARY OF THE INVENTION

Therefore, an objective of the present invention is to provide an apparatus for manufacturing molded processed food that can manufacture planar molded processed food having non-dense and dense states, i.e. heterogeneous eating texture.

According to one aspect of the present invention, there is provided an apparatus for manufacturing molded processed food that places at rest pieces of food material with a predetermined size on a resting surface of a lower mold, and uses an upper mold to press the pieces into a thin molded processed food, wherein the apparatus comprises:

a mold mechanism comprising the upper mold and the lower mold,

a rotation mechanism for rotating at least either one of the upper mold and the lower mold of the mold mechanism around a rotating shaft which is perpendicular to the resting surface; and

a first moving mechanism for moving the upper mold in closer and separated directions to/from the lower mold.

According to one aspect of the present invention, there is provided an apparatus for manufacturing molded processed food that places at rest pieces of food material with a predetermined size on a resting surface of a lower mold, and uses an upper mold to press the pieces into a thin molded processed food, while moving the upper mold and the lower mold toward the resting surface, wherein the apparatus comprises:

a mold mechanism comprising the upper mold and the lower mold in which the upper mold can move,

a rotation mechanism for rotating the upper mold of the mold mechanism around a rotating shaft which is perpendicular to the resting surface;

a first moving mechanism for moving the upper mold in closer and separated directions to/from the lower mold; and

a second moving mechanism for moving either one of the upper mold and the lower mold toward the resting surface.

According to one aspect of the present invention, there is provided an apparatus for manufacturing molded processed food that places at rest pieces of food material with a predetermined size on one end of a resting surface of a lower mold and uses an upper mold to press the pieces into a thin molded processed food, while moving the upper mold and the lower mold toward the resting surface, wherein the apparatus comprises:

a mold mechanism comprising the upper mold and the lower mold in which the upper mold can move,

a rotation mechanism for rotating the upper mold of the mold mechanism around a rotating shaft which is perpendicular to the resting surface;

a first moving mechanism for moving the upper mold in closer and separated directions to/from the lower mold; and

a second moving mechanism for moving either one of the upper mold and the lower mold toward the resting surface.

According to one aspect of the present invention, there is provided an apparatus for manufacturing molded processed food that places at rest pieces of food material with a predetermined size on a resting surface of a lower mold and uses an upper mold to press the pieces into a thin molded processed food, while moving the upper mold and the lower mold toward the resting surface, wherein the apparatus comprises:

a mold mechanism comprising the upper mold and the lower mold in which the upper mold can move,

an inclining mechanism for inclining a food-contact surface at a predetermined angle to a resting surface of the lower mold, the food-contact surface being a surface of the upper mold of the mold mechanism with which to press the pieces of food material;

a rotation mechanism for rotating the food-contact surface inclined at the predetermined angle by the inclining means, around a rotating shaft which is perpendicular to the resting surface;

a first moving mechanism for moving the upper mold in closer and separated directions to/from the lower mold; and

a second moving mechanism for moving either one of the upper mold and the lower mold toward the resting surface.

According to one aspect of the present invention, there is provided an apparatus for manufacturing molded processed food that places at rest pieces of food material with a predetermined size on a resting surface, and conveys the pieces of food material in a predetermined direction while using an upper mold to press the pieces of food material into a thin molded processed food in the conveying path, wherein the apparatus comprises:

a conveying mechanism for conveying the pieces of food material placed at rest on the resting surface and; and

a rotation mechanism for rotating the upper mold that presses at a predetermined angle the pieces of food material conveyed by the conveying mechanism.

According to one aspect of the present invention, there is provided an apparatus for manufacturing molded processed food that places at rest pieces of food material with a predetermined size on a resting surface of a lower mold, and conveys in a predetermined direction the pieces of food material while using an upper mold to press the pieces of food material into a thin molded processed food in the conveying path, wherein the apparatus comprises:

a conveying mechanism for conveying the pieces of food material placed at rest on the resting surface and; and

a rotation mechanism for rotating the upper mold around a rotating shaft which is perpendicular to the resting surface;

a first moving mechanism for moving the upper mold in pressing and separating directions with respect to the pieces of food material; and

a second mechanism for moving the upper mold along the conveying direction of the conveying mechanism.

According to one aspect of the present invention, there is provided a method for manufacturing molded processed food in which pieces of food material with a predetermined size are placed at rest on a resting surface of a lower mold, and an upper mold is used to press the pieces of food material, wherein at least either one of the upper mold and the lower mold is used to press and mold the pieces of food material into a thin molded processed food, the mold rotating around a rotating shaft which is perpendicular to the resting surface.

According to one aspect of the present invention, there is provided a method for manufacturing molded processed food in which a conveying mechanism is used to convey pieces of food material with a predetermined size in a predetermined direction, and an upper mold is used to press the pieces of food material, wherein the conveyed pieces of food material are pressed by a food-contact surface of the rotating upper mold inclined at a predetermined angle, to mold the pieces of food material into thin molded processed food.

### BRIEF DESCRIPTION OF THE DRAWINGS

FIG. 1 is a mimetic exploded perspective view of a portion of an apparatus for manufacturing molded processed food according to a first embodiment.

FIGS. 2(a) to 2(f) are drawings each showing a bottom view of a food-contact surface and a side view of an upper mold.

FIG. 3 is an illustration of an apparatus for manufacturing molded processed food according to a first embodiment with pieces of food material placed therein.

FIG. 4 is an illustration of an apparatus for manufacturing molded processed food according to a first embodiment with pieces of food material been pressed by the upper mold.

FIG. 5 is an illustration of an apparatus for manufacturing molded processed food according to a first embodiment from which has been removed a receiving tray on which the thinly molded processed food is placed at rest.

FIG. 6 is an illustration of applying food binder on thinly molded processed food.

FIG. 7 is an illustration of heating thinly molded processed food on which food binder has been applied.

FIG. 8 is a flowchart to illustrate a manufacturing method in an apparatus for manufacturing molded processed food according to a first embodiment.

FIG. 9 is a mimetic exploded perspective view of a portion of an apparatus for manufacturing molded processed food according to another embodiment.

FIG. 10 is a perspective view of an inclining mechanism.

FIG. 11 is a mimetic exploded perspective view of a portion of an apparatus for manufacturing molded processed food according to a second embodiment.

FIG. 12 is an illustration of an apparatus for manufacturing molded processed food according to a second embodiment with pieces of food material placed therein.

FIG. 13 is an illustration of an apparatus for manufacturing molded processed food according to a second embodiment which is pressing pieces of food material on one end of a resting surface plate.

FIG. 14 is an illustration of an apparatus for manufacturing molded processed food according to a second embodiment with an upper mold been moved to the other end of a resting surface plate.

FIG. 15 is an illustration of an apparatus for manufacturing molded processed food according to a second embodiment from which has been removed a receiving tray on which the thinly molded processed food is placed at rest.

FIG. 16 illustrates a process of shaping thinly molded processed food into a form, in which FIG. 16(a) illustrates a mold with the food placed at rest therein, and FIG. 16(b) the food been rectangularly shaped by the mold.

FIG. 17 is a flowchart to illustrate a manufacturing method in an apparatus for manufacturing molded processed food according to a second embodiment.

FIG. 18 shows mimetic diagrams of a portion of an apparatus for manufacturing molded processed food according to a third embodiment, 18(a) being a front view and 18(b) a side view of the apparatus.

FIG. 19 illustrates pieces of food material placed at rest between guides for the pieces and then pressed by an upper mold, FIG. 19(a) being a front view and FIG. 19(b) a side view thereof.

FIG. 20 is an illustration of applying food binder on and then heating thinly molded processed food, FIG. 20(a) being a front view and FIG. 20(b) a side view thereof.

FIG. 21 is a mimetic perspective view of a portion of an apparatus for manufacturing molded processed food according to another embodiment.

FIG. 22 is a mimetic perspective view of a portion of an apparatus for manufacturing molded processed food according to a further embodiment.

FIG. 23 is a mimetic perspective view of a portion of an apparatus for manufacturing molded processed food according to yet another embodiment.

### DESCRIPTION OF THE PREFERRED EMBODIMENT

### 1st Embodiment

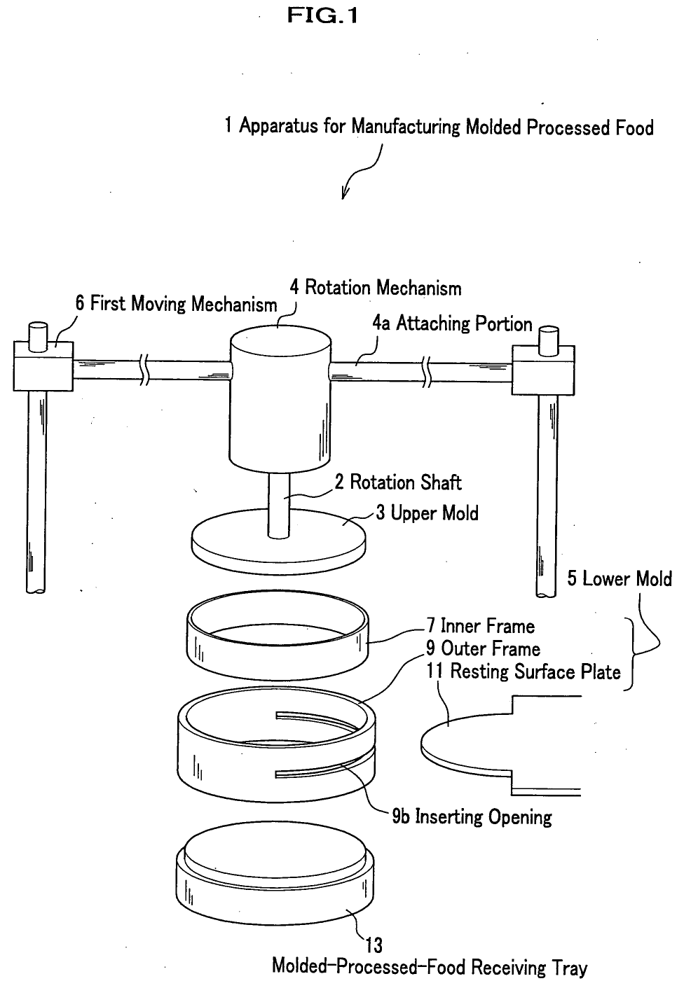

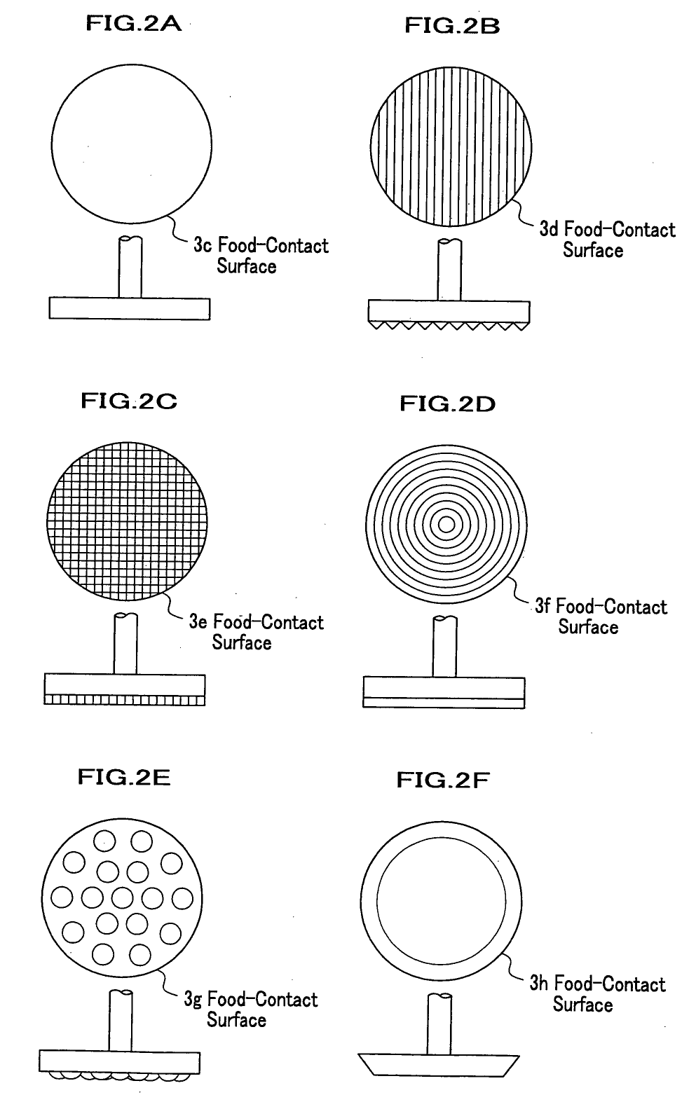

Now, referring to FIGS. 1 and 2, a first embodiment of an apparatus for manufacturing molded processed food according to the present invention will be described. FIG. 1 is a mimetic exploded perspective view of a portion of the apparatus for manufacturing molded processed food. FIGS. 2(a) to 2(i) are drawings each showing a bottom view of a food-contact surface and a side view of an upper mold.

As shown in FIG. 1, the apparatus comprises an upper mold 3 and a lower mold 5 of a mold mechanism, a rotation mechanism for rotating the upper mold 3 through a rotation shaft 2, and a first moving mechanism 6 for moving the upper mold 3 in closer and separated directions to/from the lower mold 5.

The upper mold 3 herein is a disc that rotates and presses down pieces of food material with a predetermined size such as crab-flavored kamaboko or steamed fish paste, boiled scallop, shrimp, fish meat, chicken meat, or vegetable. The rotation shaft 2 is coupled to the center of the upper surface of the upper mold 3. The column-shaped shaft 2 conveys the rotating driving force form the rotation mechanism 4. A food-contact surface 3c of the lower surface of the upper mold 3 is flat, as shown in FIG. 2(a). The peripheral surface between the upper and lower surfaces of the upper mold 3 preferably has more than a level of height dimension.

The food-contact surface of the upper mold 3 more preferably has concavities and convexities, as shown in FIGS. 2(b) to 2(e).

That is, a contact surface 3d preferably has a plurality of parallel linear convexities each having a triangular cross section, as shown in FIG. 2(b). A food-contact surface 3e may preferably have a plurality of quadrangular concavities in a grid framework, as shown in FIG. 2(c). A food-contact surface 3f may preferably have a plurality of circular convexities concentric with the food-contact surface 3f, as shown in FIG. 2(d). A food-contact surface 3g may preferably-have a plurality of hemispherical convexities, as shown in FIG. 2(e). A food-contact surface 3f may preferably have a taper, rather than concavities and convexities, as shown in FIG. 2(f).

As shown in FIG. 1, the lower mold 5 herein comprises a cylindrical inner frame 7, a cylindrical outer frame 9, and a resting surface plate (resting surface) 11 detachably provided to the outer frame 9, having a rectangular shape with a semicircle portion at one edge thereof. The inner frame 7 has an inside diameter slightly larger than the outside diameter of the upper mold 3. The outer frame 9 has an inside diameter slightly larger than the outside diameter of the inner frame 7. The inner frame 7 is fit to the outer frame 9 detachably along the internal perimeter surface thereof. At the center of the up-and-down direction of the outer frame 9, an inserting opening 9b is formed through which the resting surface plate 11 is inserted. The opening 9b is formed around half of the circumference of the outer frame 9. The plate 11 on which to place at rest the pieces of food material can be detachably slid from the outer frame 9 through the opening 9b, and is inserted into the outer frame 9 without any gap form the inner surface thereof. The semicircle portion of the resting plate 11 has a radius slightly smaller than half of the inside diameter of the outer frame. The rectangular portion of the plate 11 has an edge in the longitudinal (width) direction which is larger than the inside diameter of the outer frame 9. The rectangular portion of the plate 11 has an edge in the crosswise direction which is larger than half of the inside diameter of the outer frame 9. A molded-processed-food receiving tray 13 for receiving food from the lower mold 5 is arranged right below the lower mold 5. The top portion of the tray 13 has an outside diameter slightly smaller than the inside diameter of the outer frame 9, and is fit to the lower part of the outer frame 9.

The rotation mechanism 4 adjusts the speed reducing ratio of a driving source such as a driving motor to convey the driving force to the rotation shaft 2. The mechanism 4 is not limited to a specific type as long as it can rotate the upper mold 3 at a predetermined rotation speed of 5-150 m/min and preferably 30-110 m/min.

The first moving mechanism 6 slidingly moves an attaching portion 4a of the rotation mechanism 4 in the up-and-down direction, along a guide such as an air cylinder, and stops the attaching portion 4a at a predetermined position. The mechanism 6 is not limited to a specific construction and may be a type where the portion is manually moved to the position.

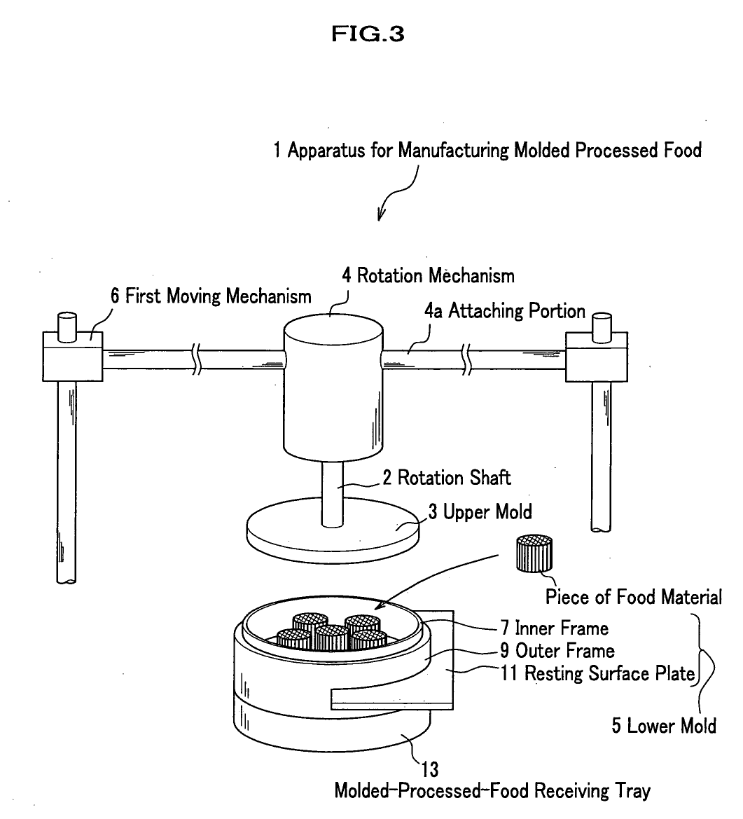

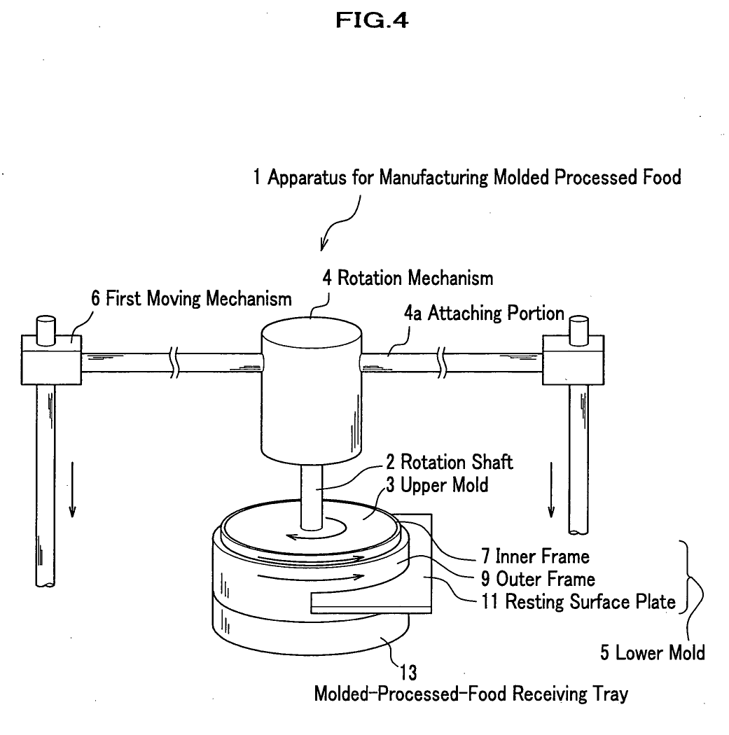

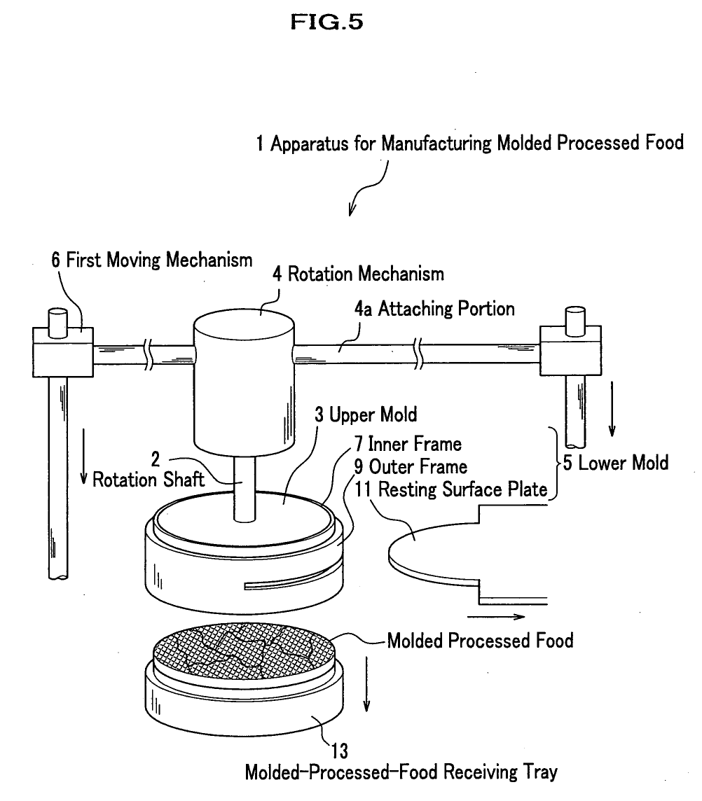

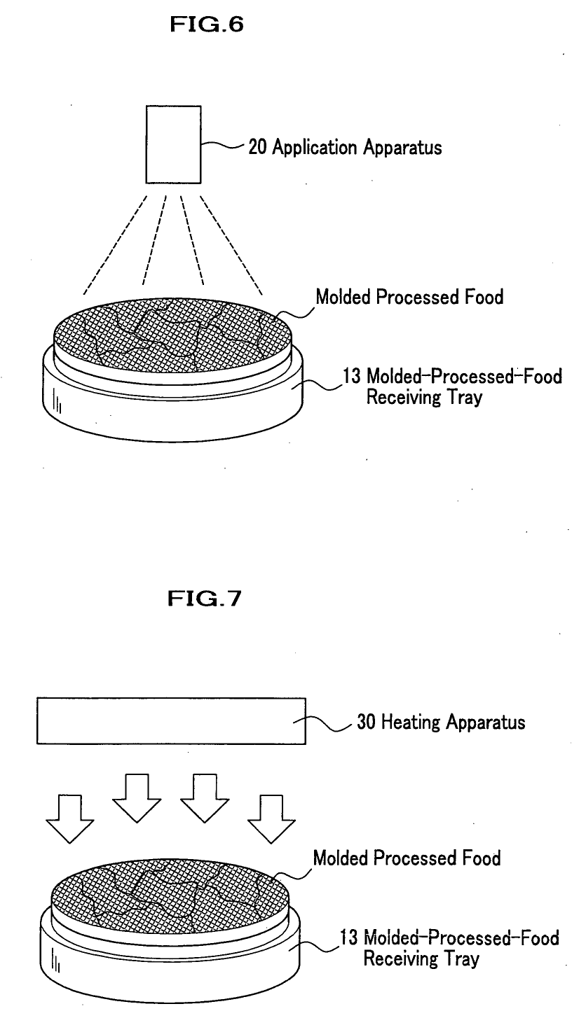

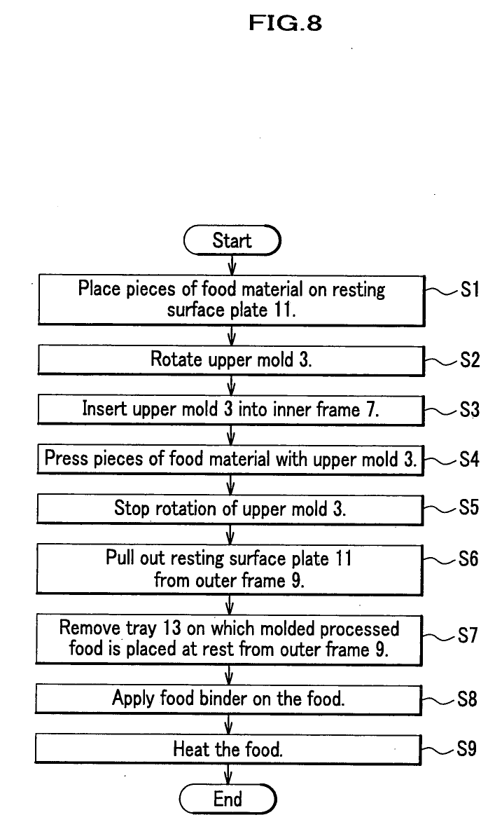

Next, referring to FIGS. 3 to 8, manufacturing method in the apparatus for manufacturing molded processed food according to the first embodiment will be described. FIG. 3 is an illustration of the apparatus for manufacturing molded processed food with pieces of food material placed therein. FIG. 4 is an illustration of the apparatus for manufacturing molded processed food with pieces of food material been pressed by the upper mold. FIG. 5 is an illustration of the apparatus for manufacturing molded processed food from which has been removed the tray on which the thinly molded processed food is placed at rest. FIG. 6 is an illustration of applying food binder on thinly molded food. FIG. 7 is an illustration of heating thinly molded processed food on which food binder has been applied. FIG. 8 is a flowchart to illustrate a manufacturing method in the apparatus for manufacturing molded processed food.

Pieces of food material processed into a predetermined shape are placed on the resting surface plate 11, as shown in FIGS. 3 and 8 (Step 1).

The rotation mechanism 4 rotates the upper mold 3, as shown in FIG. 8 (Step 2).

The first moving mechanism 6 rotates the upper mold 3 which is inserted into the inner frame 7 of the lower mold 5 (Step 3).

The rotating upper mold 3 presses the pieces of food material, loosening or breaking the fibers of the food pieces, as shown in FIGS. 4 and 8 (Step 4). Here, the distance between the food-contact surface 3c of the upper mold 3 and the resting surface plate 11 is 0.2-50 mm, and preferably 5-25 mm.

The rotation of the upper mold 3 is stopped as shown in FIG. 8 (Step 5).

The plate 11 is pulled out from the outer frame 9 by a pulling-out mechanism not shown, as shown in FIGS. 5, 8 (Step 6). Then, the first moving mechanism 6 moves down the upper mold 3 to place at rest the thinly molded processed food onto the tray 13 and then to remove the tray from the outer frame 9 of the lower mold 5 (Step 7).

Next, an adhesive liquid food material (hereinafter referred to as “food binder”) is applied on the food on the tray 13 by an application apparatus 20, as shown in FIGS. 6 and 8 (Step 8).

Then, a heating apparatus 30 heats the food placed at rest on the tray 13, as shown in FIGS. 7 and 8. (Step 9) According to the apparatus of the present embodiment, a planar molded processed food can be manufactured, having an improved appearance due to fibers oriented toward a same direction, as well as heterogeneous eating texture having both non-dense and dense states of the fibers. Further, even when the peripheral rim of the processed food adheres to the inner frame 7, the food can be easily removed from the lower mold 5 since the inner frame 7 can move along the inner peripheral surface of the outer frame 9.

According to the apparatus of the embodiment, it is further facilitated to create air layers in the food material in the food production, because the food-contact surface at the bottom of the upper mold 3 with concavities and convexities as shown in FIGS. 2b to 2e involve with the food material when the mold 3 rotates. Also, with the food-contact surface 3h having a taper as shown in FIG. 3f, a flat molded processed food can be obtained when the pieces are placed at rest at the center of the plate 11.

Moreover, according to the apparatus 1 of the embodiment, after the upper mold 3 presses down the pieces, the plate 11 can be slid to remove the thinly molded processed food from the lower side of the lower mold 9.

It is to be noted that the invention is not limited to the apparatus as set forth in the first embodiment but various modifications are possible within the same technical scope of the invention.

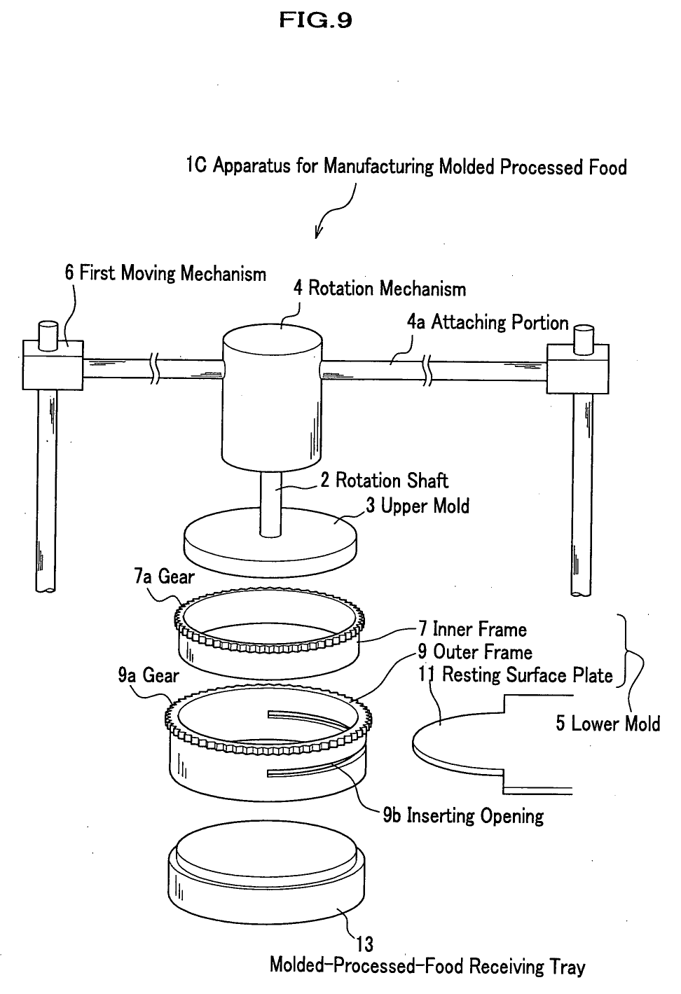

For instance, an apparatus for manufacturing molded processed food 1C as shown in FIG. 9 also falls within the technical scope of the invention, wherein a gear of a second rotation mechanism (frame rotation mechanism) not shown engages with a gear 7a integrally formed at the upper outer surface of the inner frame 7, the mechanism then rotates to rotate the inner frame in an opposite direction from the upper frame 3, a gear 9a integrally formed at the upper outer surface of the outer frame 9 engages with a third rotation mechanism (frame rotation mechanism) 4 not shown, and the third mechanism causes the outer frame 9 to rotate in an opposite direction from the upper frame 3 and at a different speed from the inner frame 7.

Also, such apparatuses fall within the technical scope of the invention that the inner and outer frames of the lower mold are integrated, the lower mold rotating in an opposite direction from the upper mold, that the lower mold rotates in the same direction as and at a different speed from the upper mold, that the upper and lower molds are polygonal, that the upper mold is smaller than the lower mold, or that the resting surface plate falls or does not slide.

Moreover, instead of using the application apparatus 20 to apply the food binder on the thinly processed food, an adhesive minced meat substance may be put on the upper surface of a food processing seal placed at rest, and spread the meat substance over the entire surface of the seal on which the thinly processed food may be bound.

### 2nd Embodiment

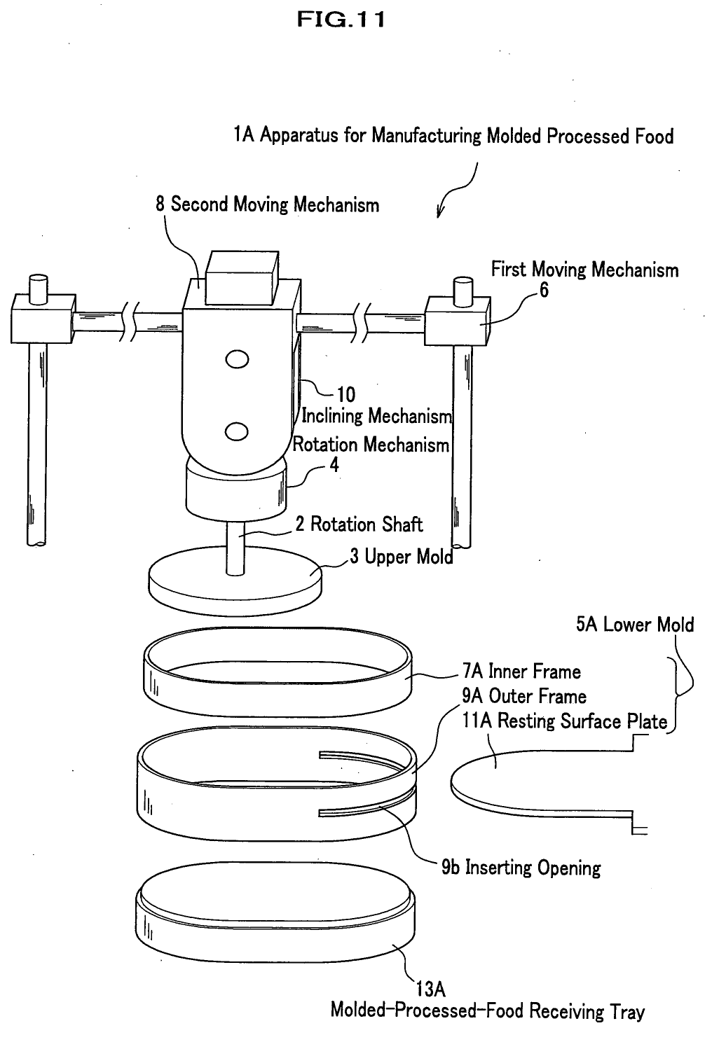

Next, a second embodiment will be described referring to FIG. 11, which is a mimetic exploded perspective view of a portion of an apparatus for manufacturing molded processed food. In the drawing, the same constructions as the first embodiment are attached with the same symbols, and will not be described.

As shown in FIG. 11, an apparatus for manufacturing molded processed food 1A comprises an upper mold 3 and a lower mold 5A of a mold mechanism, a rotation mechanism 4 for rotating the upper mold 3 through a rotation shaft 2, a first moving mechanism 6 for moving the upper mold 3 in closer and separated directions to/from the lower mold 5A, a second moving mechanism 8 for moving the upper mold 3 parallel to the longitudinal direction of a resting surface plate 11A of the lower mold 5A, and an inclining mechanism 10 for inclining the upper mold 3 at a predetermined angle to the lower mold 5A.

The lower mold 5A herein comprises a tubular inner frame 7A which horizontal cross section having linear upper and lower ends and semicircles on left and right ends, a tubular outer frame 9A which horizontal cross section having linear upper and lower ends and semicircles on left and right ends, and the resting surface plate 11A providing the bottom of the outer frame 9A. The plate 11A has a combined shape of semicircles and a rectangle. A semicircle portion of the inner peripheral of the inner frame 7A has a diameter same as the width of the rectangular portion of the inner peripheral of the inner frame 7A. A semicircle portion of the outer peripheral of the inner frame 7A has a diameter same as the width of the rectangular portion of the outer peripheral of the inner frame 7A. A semicircle portion of the inner frame 7A has a diameter slightly larger than that of the upper mold 3.

A semicircle portion of the inner peripheral of the outer frame 9A has a diameter same as the width of the rectangular portion of the inner peripheral of the outer frame 9A. A semicircle portion of the inner peripheral of the outer frame 9A has a diameter slightly larger than that of the semicircle portion of the outer peripheral of the inner frame 7A. A rectangular portion of the inner peripheral of the outer frame 9A has a crosswise length slightly larger than that of a rectangular portion of the outer peripheral of the inner frame 7A. The inner frame 7A is inserted into the outer frame 9A.

At the center portion in the up-and-down direction of the outer frame 9A, an inserting opening 9b is formed through which the resting surface plate 11A is inserted. The opening 9b is formed at the semicircle portion of the outer frame 9A. The plate 11A on which to place at rest the food pieces can be detachably slid from the outer frame 9A through the inserting opening 9b. The plate 11A is inserted into the outer frame 9A without any gap from the inner surface of the outer frame 9A, and designed so that the rectangular portion protrudes from the outer frame 9. Peripheral surface of the plate 11A is formed to abut with the inner surface of the outer frame 9A for the portion of the outer frame 9A except the inserting opening 9b.

Here, the tray 13A is formed according to the shape of the lower mold 5A. The top of the tray 13A is formed into a step shape and is constructed to engage with the lower mold 5A.

The second moving mechanism 8 moves the upper mold 3 parallel to the plate 11A and in the longitudinal direction of the lower mold 5A. The construction of the mechanism 8 is not limited to a specific type and that of a cylinder, for example, may be employed.

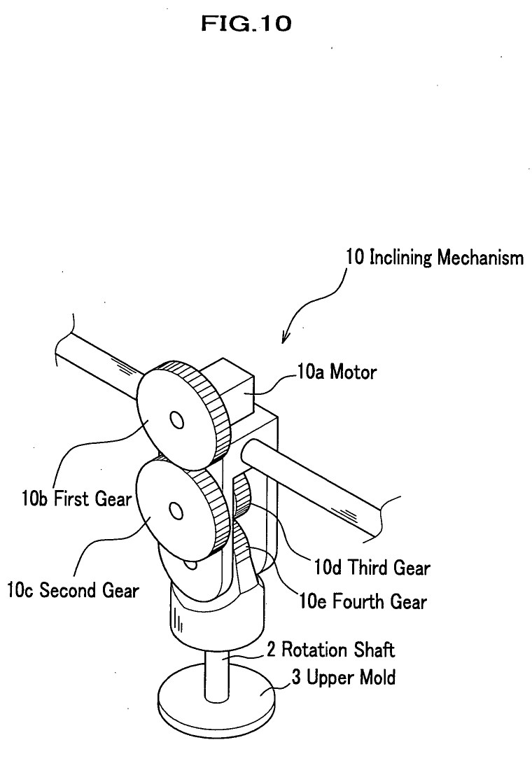

Now, the inclining mechanism will be described with reference to FIG. 10 which is a perspective view illustrating an inclining mechanism. As shown in FIG. 10, the inclining mechanism 10 comprises a first gear 10b supported by a rotation shaft of a motor 10a, a second gear 10c engaging with the first gear 10b, a third gear 10d supported by the second gear 10c, and a forth gear 10e engaging with the third gear 10d. The fourth gear 10e has teeth on the upper portion to incline the food-contact surface 3c of the upper mold 3 at a predetermined angle to the plate 11. The gear 10e has no tooth on the lower portion thereof Rotation of the motor 10a causes the first gear 10b that is supported by the rotation shaft of the motor 10a, the second gear 10c engaging with the first gear 10b, and the third gear 10d supported by the second gear 10c, to rotate in succession. Here, since the fourth gear 10e has teeth only on the upper portion, when the third gear 10d rotates clockwise, for instance, engagement of the third gear 10d with the rightmost tooth of the forth gear 10e stops the rotation of the third gear 10d. This results in the food-contact surface 3c inclined leftward at a predetermined angle to the plate 11 which is 5°-60° and preferably 10°-30°.

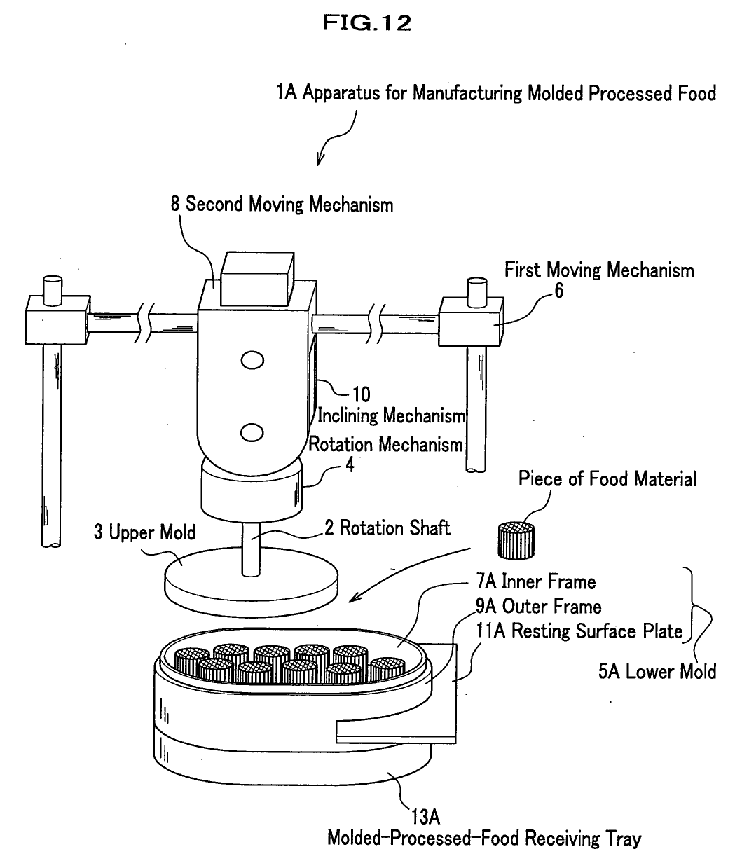

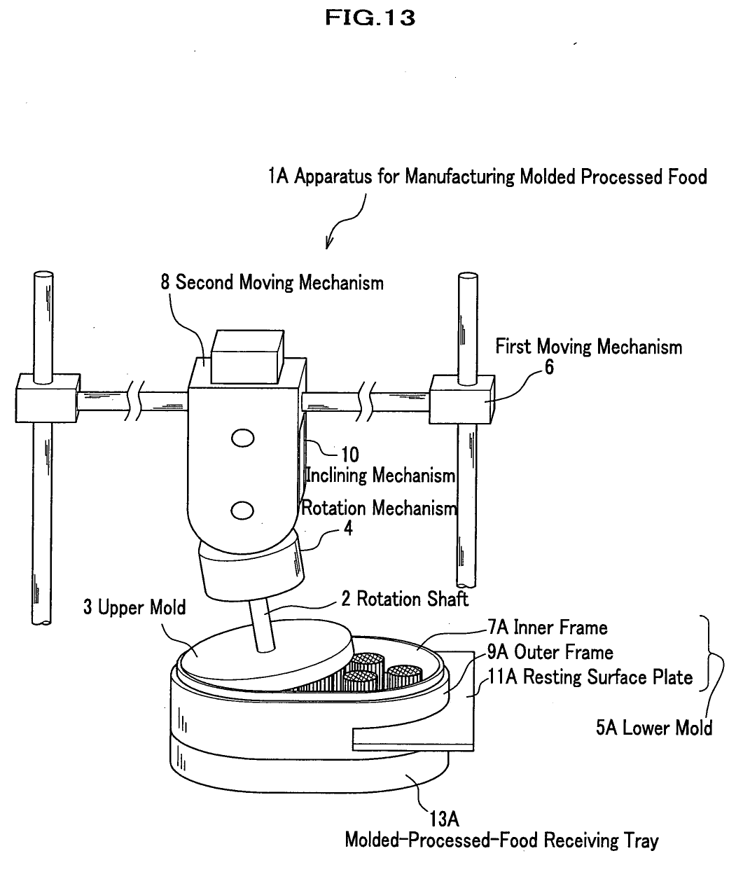

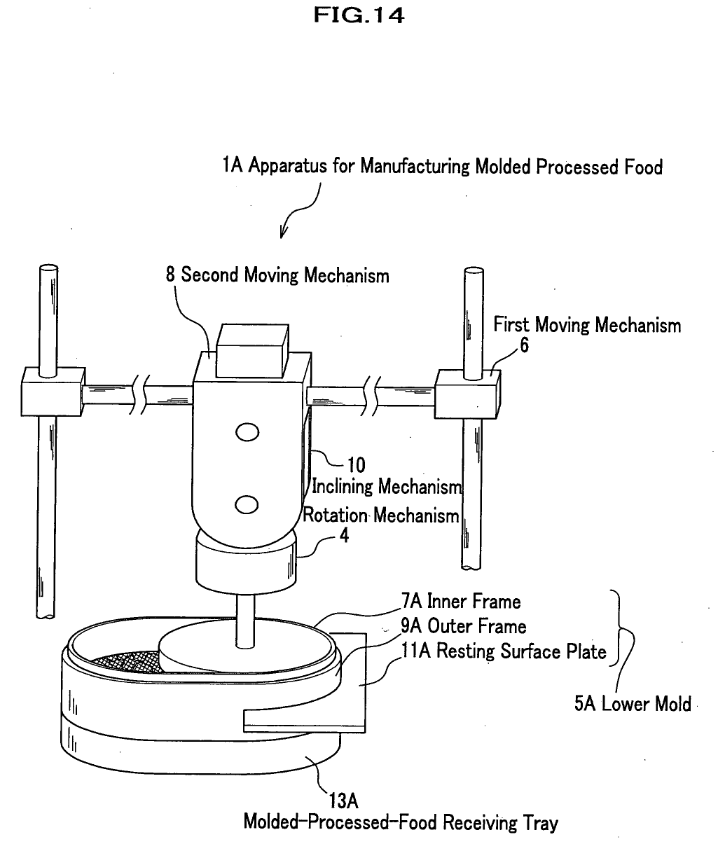

Next, referring to FIGS. 12 to 17, manufacturing method in the apparatus 1A according to the second embodiment will be described. FIG. 12 is an illustration of an apparatus for manufacturing molded processed food with pieces of food material placed therein. FIG. 13 is an illustration of an apparatus for manufacturing molded processed food which is pressing pieces of food material. FIG. 14 is an illustration of an apparatus for manufacturing molded processed food with the upper mold been moved.

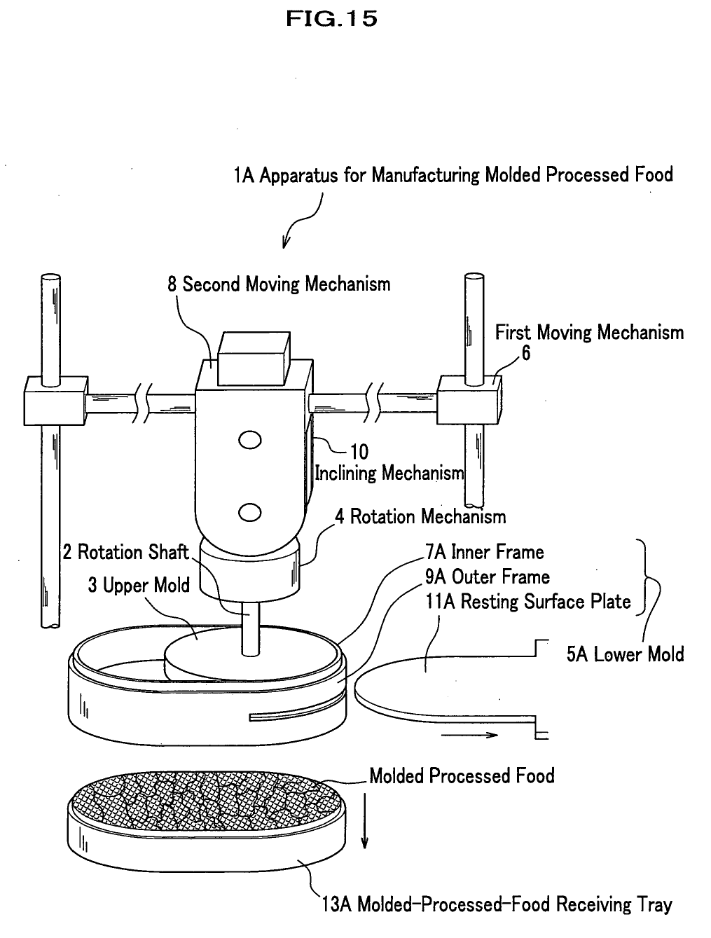

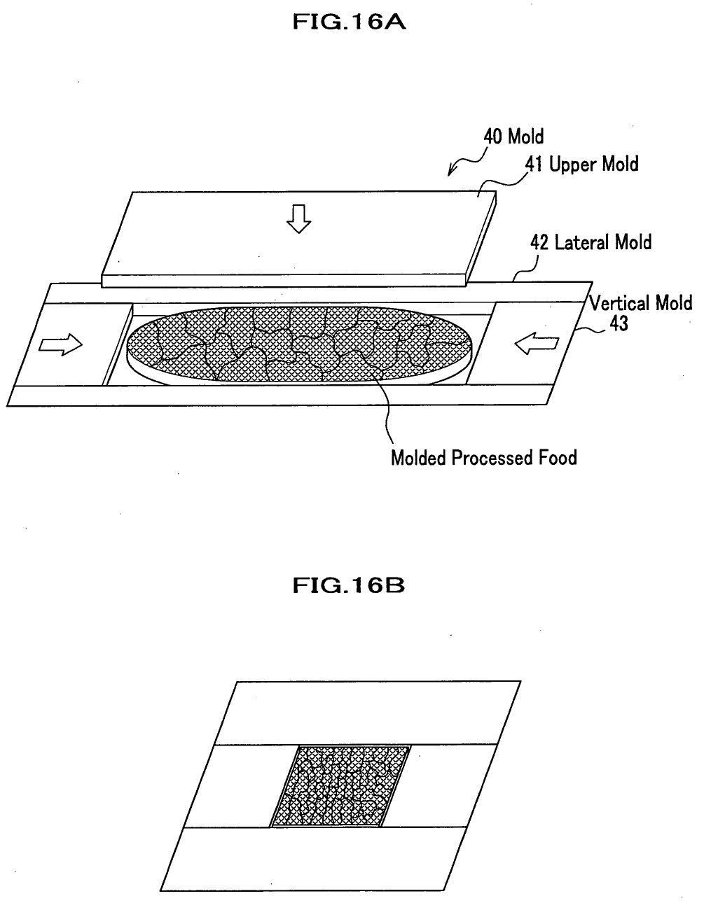

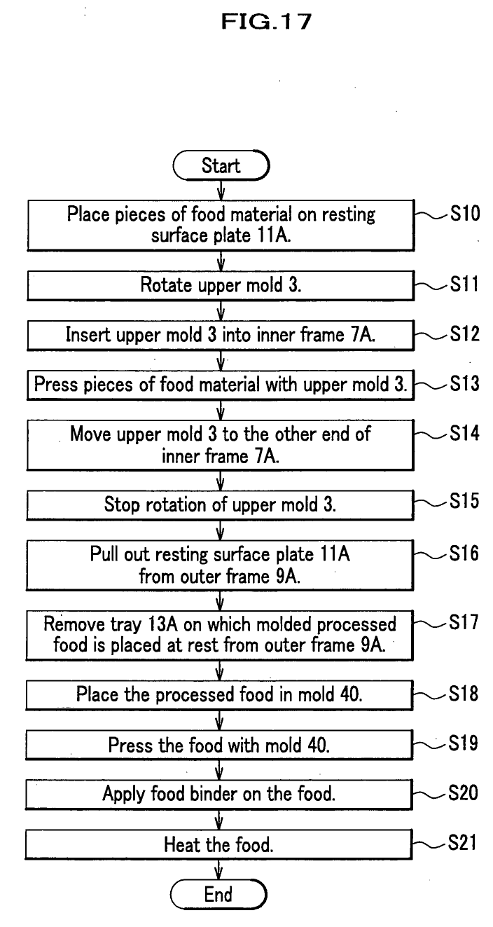

FIG. 15 is an illustration of an apparatus for manufacturing molded processed food from which has been removed the tray on which the thinly molded processed food is placed at rest. FIG. 16 illustrates a process of molding the thinly molded processed food into a shape, in which FIG. 16(a) illustrates a mold with the processed food placed at rest therein, and FIG. 16(b) the food been rectangularly molded. FIG. 17 is a flowchart to illustrate a manufacturing method in an apparatus for manufacturing molded processed food.

Pieces of food material processed in a predetermined shape are placed on the resting surface plate 11A of the apparatus 1A, as shown in FIGS. 12 and 17 (Step 10).

The upper mold 3 of the apparatus 1A is rotated by the rotation mechanism 4, as shown in FIG. 17 (Step 11).

The rotating upper mold 3 is moved down by the first moving mechanism 6 toward one end of the plate 11A in the inner frame 7A of the lower 5A, with the food-contact surface of the upper mold 3 inclined at a predetermined angle to the plate 11A by the inclining mechanism 10 (Step 12). The distance between the food-contact surface 3c of the upper mod 3 and the plate 11A is 0.2-50 mm, and preferably 5-25 mm. The inclination angle between the surface 3c and the plate 11A is 5°-60°, and preferably 10°-30°.

The pieces are pressed by the rotating upper mold 3, as shown in FIGS. 13 and 17 (Step 13).

The pieces are pressed by the rotating upper mold 3 moving to the other end of the plate 11, in such a manner that the surface 3c is parallel to the plate 11A when moved to the other end, as shown in FIGS. 14 and 17 (Step 14).

The rotation of the upper mold 3 is stopped, as shown in FIG. 17 (Step 15). Then, the mold 3 is moved up and separated from the lower mold 5A.

The plate 11A is pulled out from the outer frame 9A of the apparatus 1A by a pulling mechanism not shown, as shown in FIGS. 15 and 17 (Step 16). The upper mold 3 is moved down by the first moving mechanism 6 to place at rest the thinly molded processed food on the tray 13A and then to remove the tray 13A from the outer frame 9A of the lower frame 5A (Step 17).

The thinly processed food is placed in a mold 40, as shown in FIGS. 16(a) and 17, (Step 18).

The food is pressed by an upper mold 41 and the vertical mold 43 is slid to mold the food into a rectangular shape, as shown in FIGS. 16(a) and 17 (Step 19). The lateral mold 42 regulates the lateral size of the food.

The food is removed from the mold 40, and applied with the food binder by an application apparatus 20, as shown in FIG. 17 (Step 20).

The food to which the binder was applied is heated by the heating apparatus 30, as shown in FIG. 17 (Step 21).

According to the apparatus 1A of the second embodiment, molded processed food can be manufactured having a size larger than the contacting area of the upper mold 3 and heterogeneous eating texture.

It is to be noted that the invention is not limited to the apparatus as described in the second embodiment, but various modifications are possible within the same technical scope the invention.

For example, an apparatus also falls within the technical scope of the invention, wherein the inner and outer frames of the lower mold are integrally formed, the inner frame rotates in an opposite direction from the upper mold, the inner frame rotates in the same direction as and at a different speed from the upper mold, or the resting surface plate drops from the outer frame or does not slide.

### 3rd Embodiment

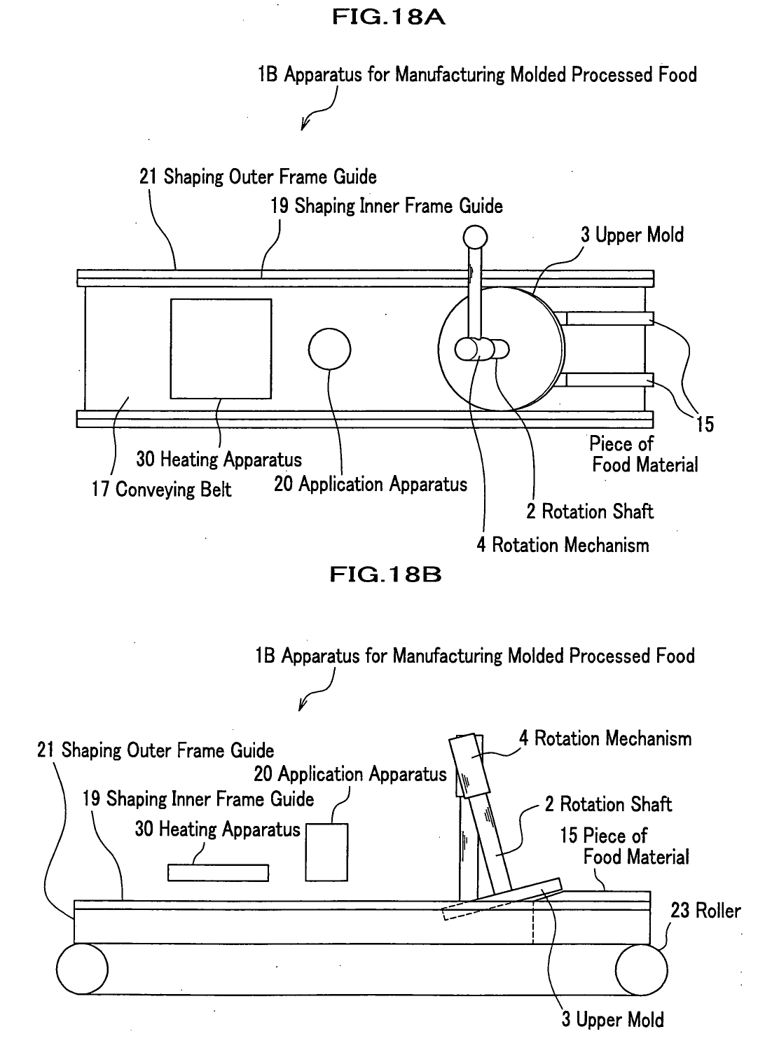

Next, referring to FIGS. 18(a) and 18(b), a third embodiment will be described. FIG. 18(a) is a front view of an apparatus for manufacturing molded processed food and 18(b) a side view thereof. In the drawings, same symbols are attached to the same constructions as the first embodiment, which will not be described.

As shown in FIGS. 18(a) and 18(b), the apparatus 1B comprises an upper mold 3, a rotation mechanism having a rotation shaft 2, guides for pieces of food material 15, a conveying belt (conveying mechanism) 17, shaping inner frame guides (edge frames) 19, and shaping outer frame guides (edge frames) 21.

The guides for pieces of food material 15 guide the food pieces to the upper mold. Each of the guides has a rectangular shape with a taper formed at upper left side thereof. The rectangular conveying belt 17 conveys the food pieces placed at rest thereon. The belt 17 has a length in the width direction which is slightly larger than the diameter of the upper mold 3. The upper mold 3 has a food-contact surface 3c held at a predetermined angle and direction to the belt 17 by a rotation mechanism. The angle is 5°-60°, and preferably 10°-30°. The direction is 0.2-50 mm, and preferably 5-25 mm.

The inner frame guides 19 regulate the width of the pieces to be pressed by the upper mold 3, and guide the thinly molded processed food pieces pressed by the upper mold 3 and placed at rest on and conveyed by the conveying belt 17. The inner surfaces of the inner frame guides 19 are flat and formed on the entire both sides of the belt 17. The outer frame guides 21 are formed on the entire both sides of the belt 17, and have a height slightly smaller than that of the inner frame guides 19. The inner frame guides 19, the outer frame guide 21, and the conveying belt 17 may be separated bodies.

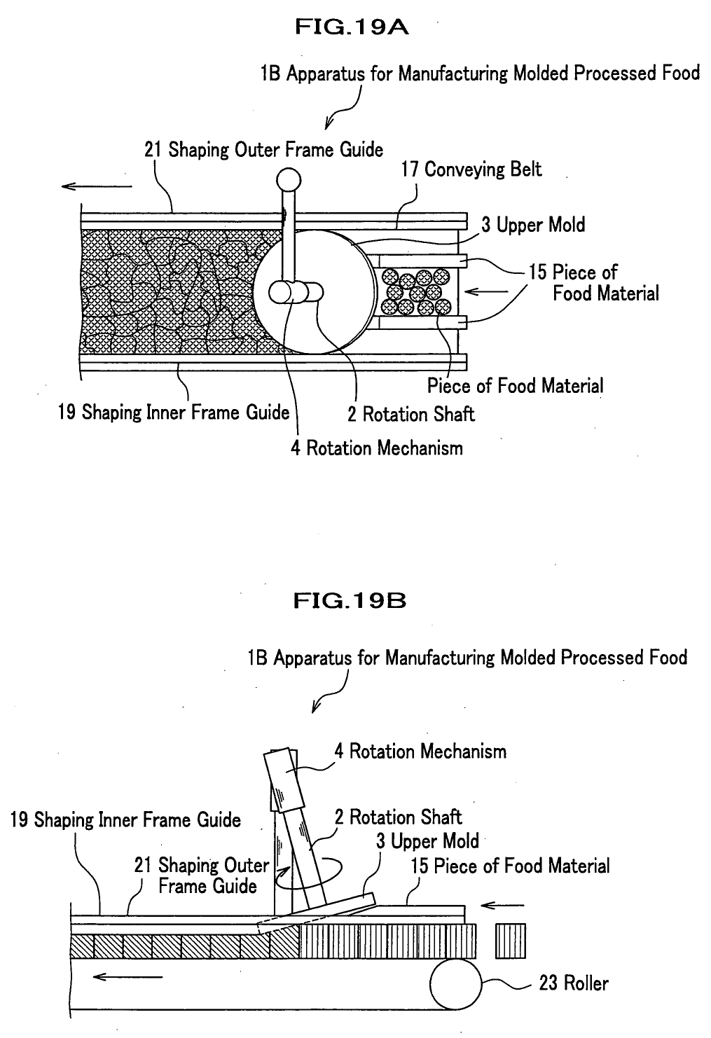

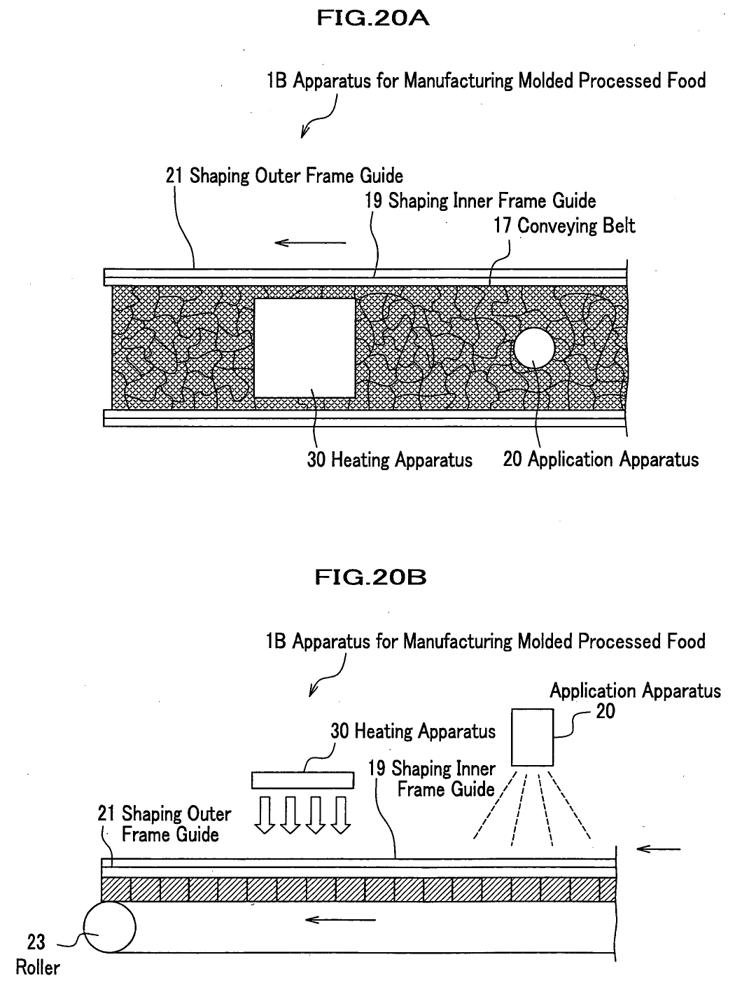

Next, referring to FIGS. 19 and 20, a manufacturing method in the apparatus for manufacturing molded processed food according to a third embodiment will be described. FIG. 19 is an illustration of pieces of food material placed at rest between guides for the pieces and then pressed by an upper mold, FIG. 19(a) being a front view and FIG. 19(b) a side view thereof FIG. 20 is an illustration of applying food binder on the thinly processed food and then heating it, FIG. 20(a) being a front view and FIG. 20(b) a side view thereof.

As shown in FIGS. 19(a) and 19(b), the conveying belt 17 is moved in the arrow direction by a means not shown, and the upper mold 3 is rotated by the rotation mechanism 4.

Using a means not shown, the food pieces are placed at rest between the guides 15.

The conveying belt 17 conveys the pieces which are next pressed by the upper mold 3, with the inner frame guide 19 regulating the width thereof.

As shown in FIGS. 20(a) and 20(b), the application apparatus 20 applies food binder on the food thinly molded by the upper mold 3, which is then heated by a heating apparatus 30.

According to the apparatus of the third embodiment, it is possible to manufacture a rectangular and planar molded processed food that can be formed in an arbitrary length, having both non-dense and dense states and therefore heterogeneous eating texture.

It is to be noted that the invention is not limited to the apparatus as described in the third embodiment, but various modifications are possible within the same technical scope of the invention.

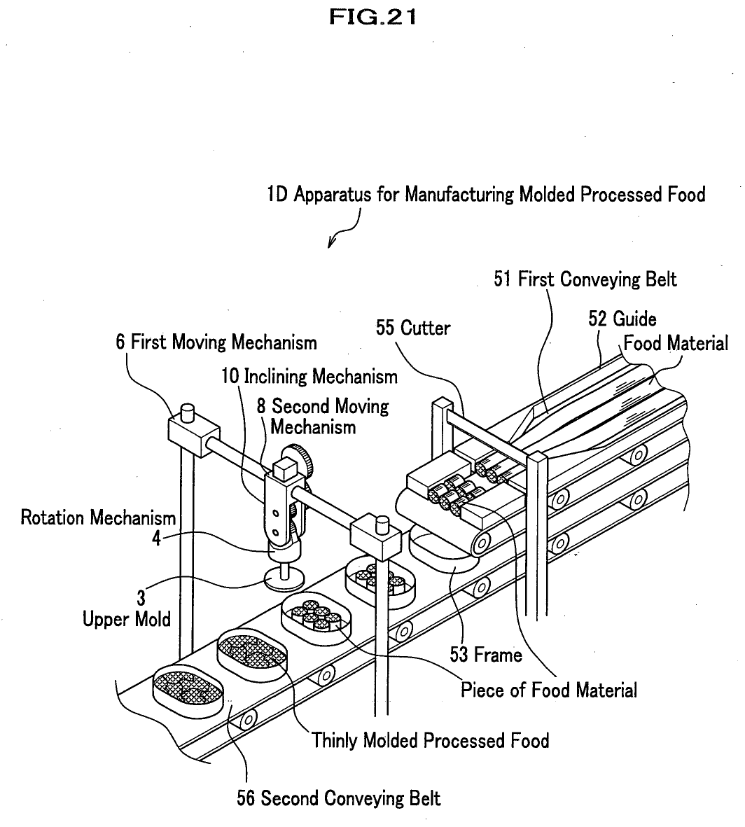

Guided by guides 52, the food material may be conveyed on a first conveying belt 51 of an apparatus for manufacturing molded processed food 1D, and cut into a predetermined size by a cutter 55, as shown in FIG. 21. The pieces of food material fall into a frame 53 on a second conveying belt 56 that moves intermittently, with the cut surfaces oriented in the up-and-down direction. Then the rotation mechanism 4 rotates the upper mold 3. An inclining mechanism 10 inclines a food-contact surface 3c of the upper mold 3 at a predetermined angle to the frame 53. A first moving mechanism 6 moves down the upper mold 3 to cause the rotating upper mold 3 to press the pieces in the frame 53. Pressing the pieces, the rotating upper mold 3 moves from one end to the other end of the frame 53, with the contact surface 3c inclined at a predetermined angle to the frame 53. Thus, a thinly molded processed food is manufactured.

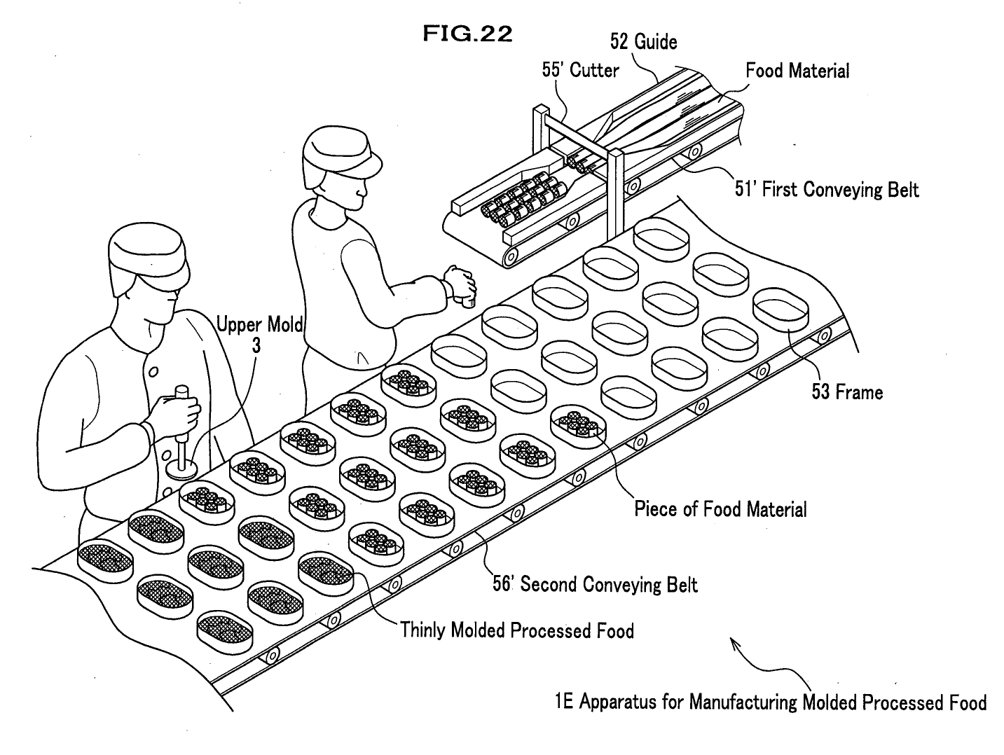

As shown in FIG. 22, instead of mechanical operation, the apparatus may be operated in the following manner. In an apparatus for manufacturing molded processed food 1E, a first conveying belt 51′ conveys the food materials, which are guided by guides 52 and cut into a predetermined size by a cutter 55. A human operator places these pieces in the frame 53 on the belt 56′ with the cutting surfaces oriented in the up-and-down direction. The operator then presses the pieces on one end of the frame 53, rotating the upper mold 3 with the food-contact surface 3c thereof inclined at a predetermined angle to the frame 53. The operator moves the upper mold 3 toward the other end of the frame 53 while pressing the pieces, such that the contact surface 3c of the mold 3 is parallel to the frame when moved to the end. The human operator thus manufactures the thinly molded processed food.

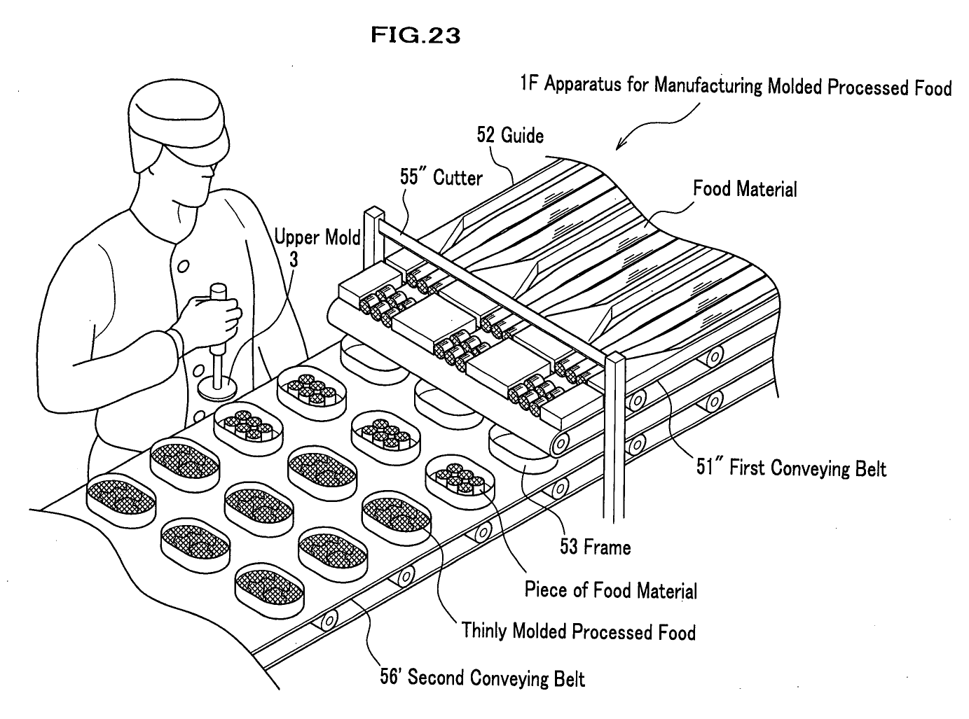

The pieces been cut may fall from the conveying belt 51″ on the frame 53 on the second conveying belt 56′ such that the cutting surfaces are oriented in the up-and-down direction, as shown in FIG. 23.

The upper mold may move toward the upstream side. In this case, the mold moves down rotating by the rotation mechanism, so that the food-contact surface is placed in a predetermined direction from the conveying belt by the first moving mechanism, and that the contact surface is inclined at a predetermined angle to the upstream side of the belt. The rotating upper mold moves toward the upstream side of the belt, pressing the food pieces. When moved to the upstream side by a predetermined distance, the upper mold is lifted up by the first moving mechanism, and moved back to the original position. This operation is repeated.

The upper mold may move in the up-and-down direction without being inclined at a predetermined angle to the conveying belt.

The inner frame guides and the outer frame guides may be integrated.

The inner frame guides or the integral guides may vibrate.

Further, the inner mold frame guide may move in a direction different from the conveying belt, or in the same direction as and at a different speed from the belt.

The integral guide may move in a different direction from the belt, or in the same direction as and at a different speed from the belt.

Next, specific examples will be described.

### 1ST EXAMPLE

In an apparatus for manufacturing molded processed food, 30 g of fragments of crab-flavored kamaboko carved into fiber-form were placed in an inner frame 7 with an inside diameter of 80 mm. Then the fragments were pressed by a rotating upper mold 3 at a pressure of 50 g/cm2 and divided into fibers that spread over a resting surface plate 11. An adhesive food material was next applied to solidify the fibers into a plate shape. Thus, round and planar crab meat-like food was manufactured, having fiber-texture and non-dense crab meat-like fibers capable of providing heterogeneous eating texture. Also, molded processed food for sandwiches was provided having a fine appearance and color tone due to the fibers arranged in a certain direction.

### 2ND EXAMPLE

As rectangular crab-meat-like food, 50 kg of fragments of crab-flavored kamaboko carved into fiber-form with a width of 85 mm and a thickness of 18 mm were consecutively placed in an apparatus for manufacturing molded processed food 1B. The fragments were conveyed at a speed of 5 m/min by a conveying belt, pressed at a pressure of 70 g/cm2 by a rotating upper mold 3 having concavities and convexities, and divided into fibers that spread over a resting surface plate 11A. An adhesive food material was then applied to solidify the fibers into a planar shape. These were cut in a predetermined amount of 55 g. Thus, molded processed food of crab-flavored kamaboko was manufactured, having fiber-texture and non-dense fibers capable of providing heterogeneous eating texture.

### 3RD EXAMPLE

45 g of fragments of crab-flavored kamaboko carved into fiber-form were placed in a lower mold of an apparatus for manufacturing rectangular molded processed food, and pressed by a rotating upper mold. The fragments were divided into fibers that spread over a resting surface plate 11A. Then an adhesive food material was applied to solidify the fibers into a plane shape. Thus, rectangular and planar molded processed food of crab-flavored kamaboko was manufactured, having fiber-texture and non-dense fibers capable of providing heterogeneous eating texture.

### 4TH EXAMPLE

Into an inner frame 7 with an inside diameter of 90 mm, 25 g of boiled scallop meat was placed, to which 3 g of boiled carrots and 3 g of green peas were added and mixed. Then the mixture was pressed by a rotating upper mold 3, which loosened the meat that spread over a resting surface plate 11 An adhesive food material was applied to solidify the mixture into a plate shape. Thus, round molded processed food of scallop meat containing ingredients was manufactured, having fiber-texture and non-dense fibers providing heterogeneous eating texture. This resulted in round molded processed food of scallop meat having preferable appearance, eating texture, taste, and flavor for a sandwich ingredient material.

### 5TH EXAMPLE

In a kneader with a capacity of 100 liters, 50 g of deveined and boiled shrimps, 5 kg of green peas, and 5 kg of boiled carrots cut into cubes were mixed. The mixed materials were densely arranged on a conveying belt 17 with a width of 95 mm and a thickness of 25 mm, and pressed and extended by a pressing plate inclined at an angle of 15° to the belt 17. Then, by means of a rotating upper mold 3 adjusted to a height of 2 mm, a stretch of molded processed shrimp food with the predetermined height was obtained. The food was cut into a length of 85 mm, packaged, and sterilize by heating at 95° C. for 35 minutes. Thus, molded processed shrimp food having preferable appearance, taste, and flavor for a sandwich ingredient was obtained.

### 6TH EXAMPLE

Into an inner mold 7 with an inside diameter of 80 mm, 30 g of fragments of crab-flavored kamaboko carved into fiber-form were placed. 7 g of mixtured red and green bell peppers cut to 2.5 mm cubes and honey corn were sprinkled onto the fragments from thereabove, which was then pressed by a rotating upper mold 3 at a pressure of 50 g/cm2. This caused the vegetables exhibiting fine color tones to disperse among the fibers that spread over a resting surface plate 11. An adhesive food material was applied to solidify the fibers into a planar shape. Thus, a round molded processed food of crab-flavored kamaboko arranged with vegetables was manufactured, having fiber-texture and non-dense crab meat-like fibers capable of providing heterogeneous eating texture. Also, molded processed food for sandwiches with a fine appearance and color tone due to the fibers arranged in a certain direction was provided.

### 7TH EXAMPLE

Into an inner mold 7 with an inside diameter of 80 mm, 30 g of fragments of crab-flavored kamaboko carved into fiber-form were placed. Then, 7 g of Bologna sausages cut into cubes were sprinkled onto the fragments from thereabove, which were then pressed by a rotating upper mold 3 at a pressure of 50 g/cm2. This caused the sausages exhibiting a good color tone to disperse among the fibers that spread over a resting surface plate 11. An adhesive food material was applied to solidify the fibers into a planar shape. Thus, round molded processed food of crab-flavored kamaboko arranged with vegetables was manufactured, having fiber-texture and non-dense crab meat-like fibers capable of providing heterogeneous eating texture. Also, molded processed food for sandwiches with a fine appearance and color tone due to the fibers arranged in a certain direction was provided.

### 8TH EXAMPLE

Into an inner mold 7 with an inside diameter of 80 mm, 30 g of fragments of crab-flavored kamaboko carved into fiber-form were placed. Then, 5 g of natural cheese cut into cubes were sprinkled onto the fragments from thereabove, which were then pressed by a rotating upper mold 3 at a pressure of 50 g/cm2. This caused the cheese exhibiting a good color tone to disperse among the fibers that spread over a resting surface plate 11. An adhesive food material was applied to solidify the fibers into a planar shape. Thus, round molded processed food of crab-flavored kamaboko arranged with vegetables was manufactured, having fiber-texture and non-dense crab meat-like fibers capable of providing heterogeneous eating texture. Also, molded processed food for sandwiches with a fine appearance and color tone due to the fibers arranged in a certain direction was provided.

### 9TH EXAMPLE

Into an inner mold 7 with an inside diameter of 80 mm, 30 g of fragments of crab-flavored kamaboko carved into fiber-form were placed. A sheet of baked egg with a thickness of 2 mm was put onto the fragments, which were then pressed by a rotating upper mold 3 at a pressure of 50 g/cm2. This caused the egg exhibiting a good color tone to disperse among the fibers of the fragments that spread over a resting surface plate 11. An adhesive food material was applied to solidify the fibers into a planar shape. Thus, round molded processed food of crab-flavored kamaboko arranged with baked egg was manufactured, having fiber-texture and non-dense crab meat-like fibers capable of providing heterogeneous eating texture. Also, molded processed food for sandwiches arranged with baked egg was obtained having a fine appearance and color tone due to the fibers arranged in a certain direction. Further, a food was provided having fine eating texture and taste and preferable as a sushi item to be decorated on sushi rise.

### 10TH EXAMPLE

Into an inner mold 7 with an inside diameter of 80 mm, 30 g of fragments of crab-flavored kamaboko carved into fiber-form were placed. Then, 7 g of chopped Shibazuke (pickled cucumber) were sprinkled onto the fragment from thereabove, and these were next pressed by a rotating upper mold 3 at a pressure of 50 g/cm2. This caused the pickles exhibiting a good color tone to disperse among the fibers that spread over a resting surface plate 11. An adhesive food material was applied to solidify the fibers into a planar shape. Thus, round molded processed food of crab-flavored kamaboko arranged with Shibazuke flavor was manufactured, having fiber-texture and non-dense crab meat-like fibers capable of providing heterogeneous eating texture. Also, a food for a rice ball ingredient was obtained having a fine appearance and color tones due to the fibers arranged in a certain direction.

### 11TH EXAMPLE

Into an inner mold 7 with an inside diameter of 80 mm, 30 g of fragments of white meat of codfish carved into fiber-form were placed. Then, 7 g of chopped Takanazuke (pickled mustard leaf) were sprinkled onto the fragments from thereabove, and these were next pressed by a rotating upper mold 3 at a pressure of 50 g/cm2. This caused the pickles exhibiting a good color tone to disperse among the codfish meat fibers that spread these over a resting surface plate 11. An adhesive food material was applied to solidify the fibers into a planar shape. Thus, round molded processed food of white fish meat arranged with Takanazuke flavor was manufactured, having fiber-texture and non-dense fibers of the meat capable of providing heterogeneous eating texture. Also, a food for a rice ball ingredient was obtained, having a fine appearance and color tones due to the fibers arranged in a certain direction.

### 12TH EXAMPLE

Into an inner mold 7 with an inside diameter of 80 mm, 30 g of fragments of chicken meat carved into fiber-form were placed. Then, 7 g of chopped shiitake (oriental black mushroom), carrot, and burdock boiled in soy sauce and sugar were sprinkled onto the fragment from thereabove, which were then pressed by a rotating upper mold 3 at a pressure of 50 g/cm2. This caused the boiled ingredients with shiitake flavor exhibiting good color tones to disperse among and on the chicken meat fibers that spread over a resting surface plate 11. An adhesive food material was applied to solidify the fibers into a planar shape. Thus, round molded processed food of chicken meat arranged with Shiitake was manufactured, having fiber-texture and non-dense fibers of the meat capable of providing heterogeneous eating texture. Also, a food for a rice ball ingredient was obtained, having a fine appearance and color tones due to the fibers arranged in a certain direction.

As described above, the present invention has the following features.

The invention according to item 1 is an apparatus for manufacturing molded processed food that places at rest pieces of food material with a predetermined size on a resting surface of a lower mold, and uses an upper mold to press the pieces into a thin molded processed food, wherein the apparatus comprises:

a mold mechanism comprising the upper mold and the lower mold,

a rotation mechanism for rotating at least either one of the upper mold and the lower mold of the mold mechanism around a rotating shaft which is perpendicular to the resting surface; and

a first moving mechanism for moving the upper mold in closer and separated directions to/from the lower mold.

According to the invention of item 1, the apparatus can use the first moving mechanism to make the upper mold approach to the lower mold, while using the rotation mechanism to rotate at least one of the upper mold and the lower mold, to press the pieces of food material on the resting surface so as to loosen or break the fibers of the pieces.

Also, the rotation of the upper or lower mold by the rotation mechanism causes deviation of the contact surfaces from the pieces, which facilitates removing the upper and lower molds from the thinly molded processed food, as well as loosening or breaking the fibers of the pieces.

Further, rotating the upper and lower molds in opposite directions by using the rotation mechanism also facilitates removing the upper and lower molds from the thinly molded processed food, as well as loosening or breaking the fibers of the pieces.

The invention according to item 2 is an apparatus for manufacturing molded processed food that places at rest pieces of food material with a predetermined size on a resting surface of a lower mold, and uses an upper mold to press the pieces into a thin molded processed food, while moving the upper mold and the lower mold toward the resting surface, wherein the apparatus comprises:

a mold mechanism comprising the upper mold and the lower mold in which the upper mold can move,

a rotation mechanism for rotating the upper mold of the mold mechanism around a rotating shaft which is perpendicular to the resting surface;

a first moving mechanism for moving the upper mold in closer and separated directions to/from the lower mold; and

a second moving mechanism for moving either one of the upper mold and the lower mold toward the resting surface.

According to the invention of item 2, the apparatus uses the first moving mechanism to make the upper mold approach to the lower mold while using the rotation mechanism to rotate the upper mold, to have the upper mold press the food pieces on the resting surface. Then the apparatus uses the second moving mechanism to move the upper or lower mold toward the resting surface while having the upper mold press the pieces, so as to allow thin molded processed food having a larger area than the upper mold to be shaped. The lower mold at least has an enough size for the lower mold to linearly move in.

The invention according to item 3 is an apparatus for manufacturing molded processed food that places at rest pieces of food material with a predetermined size on one end of a resting surface of a lower mold and uses an upper mold to press the pieces into a thin molded processed food, while moving the upper mold and the lower mold toward the resting surface, wherein the apparatus comprises:

a mold mechanism comprising the upper mold and the lower mold in which the upper mold can move,

a rotation mechanism for rotating the upper mold of the mold mechanism around a rotating shaft which is perpendicular to the resting surface;

a first moving mechanism for moving the upper mold in closer and separated directions to/from the lower mold; and

a second moving mechanism for moving either one of the upper mold and the lower mold toward the resting surface.

According to the invention of item 3, the apparatus uses the first moving mechanism to make the upper mold approach to the lower mold, while using the rotation mechanism to rotate the upper mold, to have the upper mold press the pieces of food material on one end of the resting surface. The apparatus then uses the first moving mechanism to separate the upper and lower molds, uses the second moving mechanism to move the upper mold along the resting surface, uses the first moving mechanism to make the upper mold approach to the lower mold, and then have the upper mold press the pieces of food material on the resting surface. This renders the whole pieces on the resting surface into thin molded processed food.

The invention according to item 4 is an apparatus for manufacturing molded processed food that places at rest pieces of food material with a predetermined size on a resting surface of a lower mold and uses an upper mold to press the pieces into a thin molded processed food, while moving the upper mold and the lower mold toward the resting surface, wherein the apparatus comprises:

a mold mechanism comprising the upper mold and the lower mold in which the upper mold can move,

an inclining mechanism for inclining a food-contact surface at a predetermined angle to a resting surface of the lower mold, the food-contact surface being a surface of the upper mold of the mold mechanism with which to press the pieces of food material;

a rotation mechanism for rotating the food-contact surface inclined at the predetermined angle by the inclining means, around a rotating shaft which is perpendicular to the resting surface;

a first moving mechanism for moving the upper mold in closer and separated directions to/from the lower mold; and

a second moving mechanism for moving either one of the upper mold and the lower mold toward the resting surface.

According to the invention of item 4, the apparatus uses the inclining mechanism to incline the food-contact surface of the upper mold at a predetermined angle to the resting surface of the lower mold, uses the first moving mechanism to make the upper mold approach to the lower mold while using the rotation mechanism to rotate the upper mold, and then have the inclined upper mold press the pieces on the resting surface. Then the second moving mechanism moves the lower mold along the food-contact surface, to render the whole pieces of food material into thin molded processed food.

The invention according to item 5 is an apparatus for manufacturing molded processed food as set forth in one of items 1 to 4, wherein the lower mold comprises:

an outer frame comprising the resting surface on which the pieces of food material are placed at rest, and a peripheral surface rising from the peripheral rim of the resting surface; and

a tubular inner frame positioned along the inner surface of the peripheral surface of the outer frame.

When the apparatus renders the food pieces placed at rest on the resting surface into a thin molded processed food, by first rotating the upper mold and then presses it onto the pieces, or first pressing the mold onto the pieces and then rotating it, the peripheral rim of the processed food may adhere to the inner frame.

In this case, according to the invention according to item 5, the inner frame can move along the inner peripheral surface of the outer frame to facilitate removing the processed food from the lower mold.

Also in a lower mold having a non-cylindrical shape, a tubular inner frame made of safe synthetic resin having an appropriate elasticity for the food can move along the inner peripheral surface of the outer frame.

The invention according to item 6 is an apparatus for manufacturing molded processed food as set forth in item 5, wherein the rotation mechanism comprises a frame rotation mechanism for rotating at least either one of the outer frame and the inner frame.

According to the invention of item 6, the apparatus uses the frame rotation mechanism to rotate the outer and inner frames, so as to facilitate removing the pieces of food from the lower frame.

With a mechanism for rotating both the outer and inner frames, the apparatus could more easily remove the pieces from the lower frame.

The invention according to item 7 is an apparatus for manufacturing molded processed food as set forth in one of items 1 to 4, wherein the resting surface is provided in a freely detachable manner from the lower mold.

The inventions according to items 8 and 9 are apparatuses for manufacturing molded processed food as set forth in items 5 and 6, respectively, wherein the resting surface is provided in a freely detachable manner from the outer frame.

According to the inventions as set forth in items 7, 8 or 9, the apparatus has the resting surface removable from the lower mold or the outer frame, and thus can take out the pressed pieces of food material from the lower side of the apparatus. Here, the outer frame may slide or drop from the lower mold or the outer frame.

The invention according to item 10 is an apparatus for manufacturing molded processed food that places at rest pieces of food material with a predetermined size on a resting surface, and conveys the pieces of food material in a predetermined direction while using an upper mold to press the pieces of food material into a thin molded processed food in the conveying path, wherein the apparatus comprises:

a conveying mechanism for conveying the pieces of food material placed at rest on the resting surface and; and

a rotation mechanism for rotating the upper mold that presses at a predetermined angle the pieces of food material conveyed by the conveying mechanism.

According to the invention as set forth in item 10, the apparatus uses an upper mold 10 to press the pieces of food material being conveyed by the conveying mechanism, the upper mold being inclined at a predetermined angle to the resting surface and rotated by the rotation mechanism.

The invention according to item 11 is an apparatus for manufacturing molded processed food that places at rest pieces of food material with a predetermined size on a resting surface, and conveys the pieces of food material in a predetermined direction while using an upper mold to press the pieces of food material into a thin molded processed food in the conveying path, wherein the apparatus comprises:

a conveying mechanism for conveying the pieces of food material placed at rest on the resting surface and; and

a rotation mechanism for rotating the upper mold around a rotating shaft which is perpendicular to the resting surface;

a first moving mechanism for moving the upper mold in pressing and separating directions with respect to the pieces of food material; and

a second mechanism for moving the upper mold along the conveying direction of the conveying mechanism.

According to the invention as set forth in item 11, the pieces of food material conveyed by the conveying mechanism are pressed by the upper mold rotating by the rotation mechanism and moving toward the pressing direction by the first moving mechanism. Further, the second moving mechanism is used to move the upper mold toward the conveying direction of the food pieces, or toward the direction orthogonal to the conveying direction and parallel to the resting surface, moving the pressing point, so as to render the pieces into molded processed food.

The inventions according to items 12 and 13 are apparatuses for manufacturing molded processed food as set forth in items 10 and 11, respectively, wherein the apparatuses each comprises edge frames provided along both sides of the resting surface on which to place at rest and convey the pieces of food material.

According to the inventions as set forth in item 12 and 13, the edge frames regulate the side surfaces of the food pieces being pressed by the upper mold, and guide the pieces after the pressing.

The invention according to item 14 is an apparatus for manufacturing molded processed food as set forth in one of items 1 to 4, 10, and 11, wherein the upper mold comprises the food-contact surface which contacts with the pieces of food material, provided with concavities and convexities.

According to the invention as set forth in item 14, the upper mold has the food-contact surface provided with the concavities and convexities that involve with the food pieces when the mold rotates. Thus, it is further facilitated to form air layers in the food material in the food production.

The invention according to item 15 is a method for manufacturing molded processed food in which pieces of food material with a predetermined size are placed at rest on a resting surface of a lower mold, and an upper mold is used to press the pieces of food material, wherein at least either one of the upper mold and the lower mold is used to press and mold the pieces of food material into a thin molded processed food, the mold rotating around a rotating shaft which is perpendicular to the resting surface.

According to the invention as set forth in item 15, the food pieces are pressed by at least one of the upper and lower molds rotating around a rotation shaft perpendicular to the resting surface, thus allowing loosening or breaking the food fibers.

The invention according to item 16 is a method for manufacturing molded processed food in which a conveying mechanism is used to convey pieces of food material with a predetermined size in a predetermined direction, and an upper mold is used to press the pieces of food material, wherein the conveyed pieces of food material are pressed by a food-contact surface of the rotating upper mold inclined at a predetermined angle, to mold the pieces of food material into thin molded processed food.

According to the invention as set forth in item 16, the pieces being conveyed are pressed by the rotating upper mold having the food-contact surface inclined at a predetermined angle, thus allowing loosening or breaking the fibers of the pieces.

According to the present invention, the apparatus for manufacturing molded processed food can manufacture thin molded processed food having both non-dense and dense states and therefore heterogeneous eating texture. Also, the rotating upper mold can be moved and pressed to the food material in the lower mold to manufacture molded processed food. This allows the apparatus to manufacture molded processed food having a contact surface larger than the upper mold and heterogeneous eating texture. Furthermore, use of inner and outer frames as the lower mold facilitates taking out the molded food from the lower mold in the food production.

According to the method for manufacturing molded processed food of the present invention, the upper mold or rotating pressing plate is used to rotatingly shape food material placed in the mold mechanism of molding frames, fragmenting the food material to create vacancies and therefore a non-dense state therein, into the molded processed food. This produces molded processed food with heterogeneous eating texture and an improved directional appearance. The method can also provide eating texture unique to a food material.

1. An apparatus for manufacturing molded processed food that places at rest pieces of food material with a predetermined size on a resting surface of a lower mold, and uses an upper mold to press the pieces into a thin molded processed food, wherein the apparatus comprises:
a mold mechanism comprising the upper mold and the lower mold,
a rotation mechanism for rotating at least either one of the upper mold and the lower mold of the mold mechanism around a rotating shaft which is perpendicular to the resting surface; and
a first moving mechanism for moving the upper mold in closer and separated directions to/from the lower mold.

2. An apparatus for manufacturing molded processed food that places at rest pieces of food material with a predetermined size on a resting surface of a lower mold, and uses an upper mold to press the pieces into a thin molded processed food, while moving the upper mold and the lower mold toward the resting surface, wherein the apparatus comprises:
a mold mechanism comprising the upper mold and the lower mold in which the upper mold can move,
a rotation mechanism for rotating the upper mold of the mold mechanism around a rotating shaft which is perpendicular to the resting surface;
a first moving mechanism for moving the upper mold in closer and separated directions to/from the lower mold; and
a second moving mechanism for moving either one of the upper mold and the lower mold toward the resting surface.

3. An apparatus for manufacturing molded processed food that places at rest pieces of food material with a predetermined size on one end of a resting surface of a lower mold and uses an upper mold to press the pieces into a thin molded processed food, while moving the upper mold and the lower mold toward the resting surface, wherein the apparatus comprises:
a mold mechanism comprising the upper mold and the lower mold in which the upper mold can move,
a rotation mechanism for rotating the upper mold of the mold mechanism around a rotating shaft which is perpendicular to the resting surface;
a first moving mechanism for moving the upper mold in closer and separated directions to/from the lower mold; and
a second moving mechanism for moving either one of the upper mold and the lower mold toward the resting surface.

4. An apparatus for manufacturing molded processed food that places at rest pieces of food material with a predetermined size on a resting surface of a lower mold and uses an upper mold to press the pieces into a thin molded processed food, while moving the upper mold and the lower mold toward the resting surface, wherein the apparatus comprises:
a mold mechanism comprising the upper mold and the lower mold in which the upper mold can move,
an inclining mechanism for inclining a food-contact surface at a predetermined angle to a resting surface of the lower mold, the food-contact surface being a surface of the upper mold of the mold mechanism with which to press the pieces of food material;
a rotation mechanism for rotating the food-contact surface inclined at the predetermined angle by the inclining means, around a rotating shaft which is perpendicular to the resting surface;
a first moving mechanism for moving the upper mold in closer and separated directions to/from the lower mold; and
a second moving mechanism for moving either one of the upper mold and the lower mold toward the resting surface.

5. An apparatus for manufacturing molded processed food as claimed in claim 1, wherein the lower mold comprises:
an outer frame comprising the resting surface on which the pieces of food material are placed at rest, and a peripheral surface rising from the peripheral rim of the resting surface; and
a tubular inner frame positioned along the inner surface of the peripheral surface of the outer frame.

6. An apparatus for manufacturing molded processed food as claimed in claim 5, wherein the rotation mechanism comprises a frame rotation mechanism for rotating at least either one of the outer frame and the inner frame.

7. An apparatus for manufacturing molded processed food as claimed in claim 1, wherein the resting surface is provided in a freely detachable manner from the lower mold.

8. An apparatus for manufacturing molded processed food as claimed in claim 5 wherein the resting surface is provided in a freely detachable manner from the outer frame.

9. An apparatus for manufacturing molded processed food as claimed in claim 6, wherein the resting surface is provided in a freely detachable manner from the outer frame.

10. An apparatus for manufacturing molded processed food that places at rest pieces of food material with a predetermined size on a resting surface, and conveys the pieces of food material in a predetermined direction while using an upper mold to press the pieces of food material into a thin molded processed food in the conveying path, wherein the apparatus comprises:
a conveying mechanism for conveying the pieces of food material placed at rest on the resting surface and; and
a rotation mechanism for rotating the upper mold that presses at a predetermined angle the pieces of food material conveyed by the conveying mechanism.

11. An apparatus for manufacturing molded processed food that places at rest pieces of food material with a predetermined size on a resting surface, and conveys the pieces of food material in a predetermined direction while using an upper mold to press the pieces of food material into a thin molded processed food in the conveying path, wherein the apparatus comprises:
a conveying mechanism for conveying the pieces of food material placed at rest on the resting surface and; and
a rotation mechanism for rotating the upper mold around a rotating shaft which is perpendicular to the resting surface;
a first moving mechanism for moving the upper mold in pressing and separating directions with respect to the pieces of food material; and
a second mechanism for moving the upper mold along the conveying direction of the conveying mechanism.

12. An apparatus for manufacturing molded processed food as claimed in claim 10, wherein the apparatus comprises edge frames provided along both sides of the resting surface on which the pieces of food material are placed at rest and conveyed.

13. An apparatus for manufacturing molded processed food as claimed in claim 11, wherein the apparatus comprises edge frames provided along both sides of the resting surface on which the pieces of food material are placed and conveyed.

14. An apparatus for manufacturing molded processed food as claimed claim 1, wherein the upper mold comprises the food-contact surface which contacts with the pieces of food material, provided with concavities and convexities.

15. A method for manufacturing molded processed food in which pieces of food material with a predetermined size are placed at rest on a resting surface of a lower mold, and an upper mold is used to press the pieces of food material, wherein at least either one of the upper mold and the lower mold is used to press and mold the pieces of food material into a thin molded processed food, the mold rotating around a rotating shaft which is perpendicular to the resting surface.

16. A method for manufacturing molded processed food in which a conveying mechanism is used to convey pieces of food material with a predetermined size in a predetermined direction, and an upper mold is used to press the pieces of food material, wherein the conveyed pieces of food material are pressed by a food-contact surface of the rotating upper mold inclined at a predetermined angle, to mold the pieces of food material into thin molded processed food.
